(19) United States
(12) Patent Application Publication
(10) Pub. No.: US 2016/0375609 A1
(43) Pub. Date: Dec. 29, 2016

(54) COMPRESSION MOLD, COMPRESSION MOLDING TOOL AND COMPRESSION MOLDING METHOD

(71) Applicant: AIRBUS OPERATIONS GMBH, Hamburg (DE)

(72) Inventors: Peter SANDER, Hamburg (DE); Axel HERRMANN, Hamburg (DE); Marc FETTE, Hamburg (DE); Jens P. WULFSBERG, Hamburg (DE)

(21) Appl. No.: 15/192,384

(22) Filed: Jun. 24, 2016

(30) Foreign Application Priority Data
Jun. 25, 2015 (EP) 15 173 874.7

(51) Int. Cl. B29C 33/02

(52) U.S. Cl. CPC B29C 33/02; B33Y 10/00

(57) ABSTRACT

A compression mold for use in a compression molding tool, is manufactured by an additive manufacturing method, particularly electron beam melting, selective laser melting, or selective laser sintering. A method for manufacturing a compression mold for use in a compression molding tool includes forming a compression mold body of the compression mold with an additive manufacturing (AM) method.

### CROSS-REFERENCE TO RELATED APPLICATION

This application claims priority to EP 15 173 874.7 filed Jun. 25, 2015, the entire disclosure of which is incorporated by reference herein.

### TECHNICAL FIELD

The present disclosure relates to a compression mold, a compression tool with such a compression mold, a compression molding method and the use of a compression mold in a compression molding method, in particular by using additive layer manufacturing (ALM), selective laser sintering (SLS) and/or solid freeform fabrication (SFF) processes for fabricating the compression mold.

### BACKGROUND

In compression molding, a molding material such as for example sheet molding compound (SMC) or bulk molding compound (BMC) which has been preheated in a conventional oven by convection or infrared radiation is positioned in a cavity of the compression mold of a compression molding tool. During the initial heating in the oven the fibers expand, resulting in a resin poor coating of the composite surface. In addition, this expansion of the fibers results in a lofting, or movement, of the fibers into the resin surface layers.

The compression mold usually includes a male molding component, often called the plunger, and a female molding component. The cavity between the male and female molding component is shaped according to the desired shape of the thermoset composite compound to be molded. Both molding components get heated and pressed against each other, for example by a hydraulic ram. The molding compound within the cavity is conformed to the molding form under the pressure applied which is usually in the range of several tens of bar.

Once the heat from the heated molding components has been transferred to the molding compound, the molding compound's temperature surpasses the curing temperature, for example 100° C. to 150° C. for polyester fiberglass resin systems. The pressure on the molding material is maintained to keep the compound in contact with all mold areas, while the heating temperature is upheld until the molding material has cured. After cooling the compression mold, the final cured composite part may be removed from the compression molding tool.

Compression molding processes conventionally employ thermosetting resins in a partially cured stage, either in the form of granules, putty-like masses, or preforms. As closed molding procedures, compression molding methods are high volume and high pressure and thus suitable for molding complex, high-strength fiberglass reinforced thermoset composite parts. Advanced composite thermoplastics may also be compression molded using chopped strands, unidirectional tapes, randomly oriented fiber mats or other woven fabrics. One of the advantages of compression molding lies in the opportunity to mold intricate parts of large dimensions.

“SMC” is a generic term including a large variety of product compositions, usually based on unsaturated polyesters, epoxy or vinylesters. SMCs may comprise additives such as lubricants or mold releases in order to improve surface finish, mold handling and other important parameters. SMC parts serve regularly as replacement parts for conventional steel or titanium components in various application fields, such as for example automotive industries or aerospace and aviation industries. SMCs may be enriched or reinforced with carbon, aramid, glassfibers and/or natural fibers such as hemp or sisal.

The different parts of compression molding tools need to be specifically designed for the desired shape and properties of the molded composite parts. This requires lots of effort, high cycle time and expensive tooling costs in manufacturing the molds and other components of variable shape. Therefore, it would be desirable to find new design approaches in manufacturing compression molding components.

Document U.S. Pat. No. 8,245,378 B2 for example discloses methods and apparatuses for manufacturing components used in the manufacture of wearable articles. Document WO 00/32327 A2 discloses a method for producing sheet forming tools. Such manufacturing process may utilize rapid prototyping machines, such as for example disclosed in document US 2005/0280185 A1.

### SUMMARY

One of the ideas of the disclosure herein is therefore to provide solutions for manufacturing components of compression molding tools, particularly in aerospace industries, which reduce cycle times, energy consumption and tooling costs as well as help to improve molded part quality.

A first aspect of the disclosure herein hence pertains to a compression mold, for a compression molding tool, the compression mold being manufactured by an additive manufacturing, AM, method.

According to a second aspect of the disclosure herein, the compression mold according to the first aspect of the disclosure herein is to be used as male and/or female mold component in a compression molding tool.

According to a third aspect of the disclosure herein, a compression molding tool comprises at least one compression mold according to the first aspect of the disclosure herein.

Finally, according to a fourth aspect of the disclosure herein, a method for manufacturing a compression mold comprises forming a compression mold body of the compression mold with an additive manufacturing, AM, method.

The idea on which the present disclosure is based is to fabricate tailor-made compression molds using an additive manufacturing method, such as for example selective laser sintering (SLS), electron beam melting (EBM) or selective laser melting (SLM). The compression molds may be either the male or the female mold component/die. The compression molds fabricated in this manner may for example be made from maraging steel, a steel type of very high strength and low carbon content. Maraging steel may comprise precipitated intermetallic compounds, for example alloys of nickel, cobalt, molybdenum, titanium, niob and/or chromium.

Among the several advantages of such compression molds are the lightweight design and concomitantly the simplified transportation. Furthermore, the compression molds may be fabricated with a high degree of structural complexity, freedom of design and intricate functional integration. The cycle times for fabricating the compression mold in that manner are significantly reduced, as well as the lead time for the design and production processes and the energy consumption during the fabrication. The material usage is optimized in AM methods since there is little to no waste material during the fabrication.

The solution of the disclosure herein offers great advantages for 3D printing or additive manufacturing (AM) technology since 3D components or objects may be printed without the additional need for subjecting the components or objects to further processing steps such as milling, cutting or drilling. This allows for a more efficient, material saving and time saving manufacturing process for objects.

Particularly advantageous in general is the reduction of costs, weight, lead time, part count and manufacturing complexity coming along with employing AM technology for printing structural components or other objects used for, employed in or being part of compression molding tools. Moreover, the geometric shape of the printed compression molds may be flexibly designed with regard to the intended functionality and desired purpose.

According to some embodiments of the compression mold, the AM method may comprise electron beam melting, EBM, selective laser melting, SLM, or selective laser sintering, SLS.

According to some further embodiments of the compression mold, the compression mold may further comprise a plurality of heating channels running through the compression mold body, the plurality of heating channels being integrally manufactured with the AM method. Those heating channels may in one embodiment run in the vicinity of the cavity surface of the compression mold.

According to another embodiment of the compression mold, the compression mold may consist of or comprise one of maraging steel, stainless steel, titanium and aluminium, particularly maraging steel 1.2709.

According to another embodiment of the compression mold, the compression mold body may additionally comprise a biomimetic structure.

According to an embodiment of the method, the AM method may comprise electron beam melting, EBM, selective laser melting, SLM, or selective laser sintering, SLS.

According to another embodiment of the method, the method may further comprise integrally manufacturing a plurality of heating channels running through the compression mold body with the AM method. In one variation, this may include forming the plurality of heating channels in the vicinity of a cavity surface of the compression mold.

### BRIEF DESCRIPTION OF THE DRAWINGS

The disclosure herein will be explained in greater detail with reference to exemplary embodiments depicted in the drawings as appended.

The accompanying drawings are included to provide a further understanding of the present disclosure and are incorporated in and constitute a part of this specification. The drawings illustrate the embodiments of the present disclosure and together with the description serve to explain the principles of the disclosure herein. Other embodiments of the present disclosure and many of the intended advantages of the present disclosure will be readily appreciated as they become better understood by reference to the following detailed description. The elements of the drawings are not necessarily to scale relative to each other. Like reference numerals designate corresponding similar parts.

FIG. 1 schematically illustrates a functional diagram of a compression molding tool according to an embodiment of the disclosure herein.

FIG. 2 schematically illustrates a flow diagram of a method for manufacturing a compression mold according to another embodiment of the disclosure herein.

### DETAILED DESCRIPTION

In the figures, like reference numerals denote like or functionally like components, unless indicated otherwise. Any directional terminology like “top”, “bottom”, “left”, “right”, “above”, “below”, “horizontal”, “vertical”, “back”, “front”, and similar terms are merely used for explanatory purposes and are not intended to delimit the embodiments to the specific arrangements as shown in the drawings.

Although specific embodiments have been illustrated and described herein, it will be appreciated by those of ordinary skill in the art that a variety of alternate and/or equivalent implementations may be substituted for the specific embodiments shown and described without departing from the scope of the present disclosure. Generally, this application is intended to cover any adaptations or variations of the specific embodiments discussed herein.

Additive layer manufacturing (ALM), selective laser sintering (SLS) and solid freeform fabrication (SFF) techniques, generally termed as 3D printing techniques, may be used in procedures for building up three-dimensional solid objects based on digital model data. 3D printing is currently used for prototyping and distributed manufacturing with multiple applications in engineering, construction, industrial design, automotive industries and aerospace industries.

Free form fabrication (FFF), direct manufacturing (DM), fused deposition modelling (FDM), powder bed printing (PBP), laminated object manufacturing (LOM), stereolithography (SL), selective laser sintering (SLS), selective laser melting (SLM), selective heat sintering (SHS), electron beam melting (EBM), direct ink writing (DIW), digital light processing (DLP) and additive layer manufacturing (ALM) belong to a general hierarchy of additive manufacturing (AM) methods. Those systems are used for generating three-dimensional objects by creating a cross-sectional pattern of the object to be formed and forming the three-dimensional solid object by sequentially building up layers of material. Any of such procedures will be referred to in the following description as AM or 3D printing without loss of generality. AM or 3D printing techniques usually include selectively depositing material layer by layer, selectively fusing or solidifying the material and removing excess material, if needed.

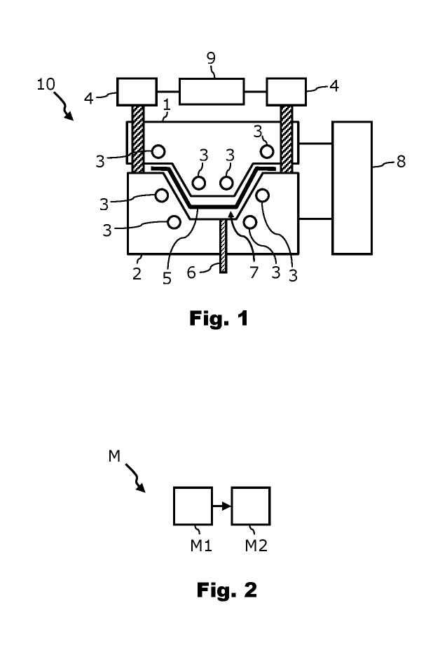

FIG. 1 schematically illustrates an exemplary compression molding tool 10. The compression molding tool 10 may generally comprise a male compression mold 1 which may be pressed down upon a female compression mold 2, for example by using a hydraulic ram 4 under the control of a ram controller 9. When the male compression mold 1 and the female compression mold 2 are brought into contact, a mold cavity 7 remains in between the compression molds 1 and 2. The shape of the mold cavity 7 generally corresponds to the negative shape of the compression molds 1 and 2.

A molding compound, such as for example a sheet molding compound (SMC) 5 may be inserted manually, robotically or in a continuous sheet rolling process into the mold cavity 7. Upon exerting pressure on the male compression mold 1, one or both of the compression molds 1 and 2 may be heated up, for example by use of a heater 8. The heater 8 may operate electrically or pneumatically, pumping heating fluid through heating channels 3 which are introduced in or through the compression molds 1 and 2. After heating up the mold compound 5 to a curing temperature between 50° C. and 300° C., depending on the type of mold compound 5 and holding the mold compound 5 at that temperature for a certain timespan, usually several minutes, the mold compound 5 is cured to a composite part, i.e. the fibers in the mold compound cross-link.

The compression molding tool 10 may comprise one or more ejector pins 6 reaching through the female compression mold 2 and configured to push out the cured composite part out of the mold cavity 7 after the compression molding tool 10 has been opened again.

Due to the location, routing, size and shape of the heating channels 3, the compression molds 1 and 2 heat up locally according to a predetermined temperature profile. This advantageously allows for maintaining an optimum temperature distribution within the composite part to be molded.

The compression molds 1 and 2 may be any type of shaped component that may be integrally manufactured using an AM or 3D printing technique. The compression molds 1 and 2 may in particular be fabricated integrally, from any material suitable for an AM or 3D printing technique. Such 3D printing process may involve selectively depositing material layer by layer with the deposited material layers being coplanar to each other and having a normal axis corresponding to the 3D printing direction. Suitable AM techniques may involve electron beam melting (EBM), selective laser melting (SLM) or selective laser sintering (SLS). The compression molds 1 and 2 may for example be manufactured from maraging steel, such as maraging steel 1.2709 (also known as X3NiCoMoTi 18-9 steel). It may also be possible to use other materials, such as for example aluminum, titanium or stainless steel. It may be possible to additionally harden, mill, chromize and/or polish the fabricated compression molds 1 and 2.

The compression molds 1 and 2 may have a compression mold body the internal structures may for example be designed according to biomimetic or bionic principles.

FIG. 2 shows a schematic illustration of a flow diagram of a method M for manufacturing a compression mold by using an additive manufacturing (AM) process. The method M may in particular be used to manufacture a compression mold 1 for use in a compression molding tool 10 as exemplarily shown in FIG. 1.

At M1, a compression mold body of the compression mold is formed using an additive manufacturing, AM, method, such as for example electron beam melting, EBM, selective laser melting, SLM, or selective laser sintering, SLS. During the forming of the compression mold body, a step M2 may include integrally manufacturing a plurality of heating channels 3 running through the compression mold body. The plurality of heating channels 3 may particularly be formed in the vicinity of a cavity surface of the compression mold. The heating channels 3 may conveniently be formed with a respective design modification of the 3D slice model underlying the AM control process. By forming heating channels 3 near the vicinity of the cavity surface, the transfer and distribution of thermal energy into and through the mold compound can be optimized in order to enhance the material quality of the cured thermoset composite parts that are to be molded using the 3D-printed compression molds.

The method M may be transcribed into computer-executable instructions on a computer-readable medium which , when executed on a data processing apparatus, cause the data processing apparatus to perform the steps of the method. Particularly, the computer-executable instructions for executing the method M may be implemented in STL file or similar format which may be processed and executed using 3D printers, AM tools and similar rapid prototyping equipment.

In the foregoing detailed description, various features are grouped together in one or more examples or examples with the purpose of streamlining the disclosure. It is to be understood that the above description is intended to be illustrative, and not restrictive. It is intended to cover all alternatives, modifications and equivalents. Many other examples will be apparent to one skilled in the art upon reviewing the above specification.

The subject matter disclosed herein can be implemented in or with software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, an or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

What is claimed is:

1. A compression mold for a compression molding tool, the compression mold being manufactured by an additive manufacturing (AM) method.

2. The compression mold according to claim 1, wherein the AM method comprises electron beam melting (EBM), selective laser melting (SLM) or selective laser sintering (SLS).

3. The compression mold according to claim 1, further comprising:
a plurality of heating channels running through the compression mold body, the plurality of heating channels being integrally manufactured with the AM method.

4. The compression mold according to claim 3, wherein the plurality of heating channels are in a vicinity of a cavity surface of the compression mold.

5. The compression mold according to claim 1, comprising maraging steel, stainless steel, titanium or aluminum.

6. The compression mold according to claim 5, consisting of maraging steel 1.2709.

7. The compression mold according to claim 1, wherein the compression mold body comprises a biomimetic structure.

8. Use of a compression mold for a compression molding tool, the compression mold being manufactured by an additive manufacturing (AM) method, the compression mold being used as male and/or female mold component in a compression molding tool.

9. A compression molding tool, comprising:
at least one compression mold being manufactured by an additive manufacturing (AM) method.

10. A method for manufacturing a compression mold, the method comprising:
forming a compression mold body of the compression mold with an additive manufacturing (AM) method.

11. The method according to claim 10, wherein the AM method comprises electron beam melting (EBM), selective laser melting (SLM) or selective laser sintering (SLS)

12. The method according to claim 10, further comprising:
integrally manufacturing a plurality of heating channels running through the compression mold body with the AM method.

13. The method according to claim 12, wherein integrally manufacturing the plurality of heating channels comprises forming the plurality of heating channels in a vicinity of a cavity surface of the compression mold.

14. A computer-readable medium comprising computer-executable instructions which, when executed on a data processing apparatus, cause the data processing apparatus to perform a method for manufacturing a compression mold, the method comprising:
forming a compression mold body of the compression mold with an additive manufacturing (AM) method.
